(19) United States
(12) Patent Application Publication
(10) Pub. No.: US 2021/0287151 A1
(43) Pub. Date: Sep. 16, 2021

(54) SYSTEMS AND METHODS FOR SURROGACY

(71) Applicant: Judy Ann Hall, Detroit, MI (US)

(72) Inventor: Judy Ann Hall, Detroit, MI (US)

(21) Appl. No.: 17/201,632

(22) Filed: Mar. 15, 2021

Related U.S. Application Data
(60) Provisional application No. 63/100,470, filed on Mar. 16, 2020.

(51) Int. Cl. G06Q 10/06; G08B 21/02

(52) U.S. Cl. CPC G06Q 10/06312; G06Q 10/06315; G08B 21/02; G06Q 10/063116

(57) ABSTRACT

An apparatus for online surrogacy including a server computing device including a processor and a memory including instructions that, when executed by the processor, cause the processor to receive a request data object including requestor information and request information from a requestor device; identify, using the request data object, surrogacy criteria corresponding to the requestor information; receive a plurality availability data objects, each availability data object including availability information for at least one corresponding surrogate; determine, based on the surrogacy criteria and the availability information for each respective availability data object, a surrogate; generate, based on the requestor information and the determined surrogate, surrogacy instructions; and transmit, to a surrogate device associated with the determined surrogate, a surrogacy instruction data object including the surrogacy instructions.

### CROSS-REFERENCES TO RELATED APPLICATIONS

This patent application claims priority to U.S. Provisional Patent Application Ser. No. 63/100,470, filed Mar. 16, 2020, which is incorporated herein by reference in its entirety.

### TECHNICAL FIELD

This disclosure relates to electronic applications for services, and in particular to systems and methods for surrogacy.

### BACKGROUND

Many purchases are made from online retailers, with products being delivered to an address selected by the purchaser. Increasingly, individuals are engaging in a number of activities, such as work, school, pet care, parenting, and the like. Periodically, an individual may have conflicting activity schedules. For example, an individual may be scheduled to attend a child's sporting event at the same time a pet is scheduled for a veterinary visit. In addition to the increasingly busier schedules of individuals, more individuals are turning to online shopping, and consequently, package delivery, for various purchases. Such increasingly busy schedules may cause the individual to be away from a delivery location at a time of delivery of a package. The delivery may also require a signature, especially for medicine.

Periodically, a purchaser may not be available at the selected address at a time of delivery. This may result in packages being left unattended, increasing the likelihood of packages being stolen or damaged due to weather or animals.

### SUMMARY

This disclosure relates generally to systems and methods for surrogacy.

An aspect of the disclosed embodiments is an apparatus for surrogacy including a server computing device including a processor and a memory including instructions that, when executed by the processor, cause the processor to receive a request data object including requestor information and request information from a requestor device. The instructions further cause the processor to identify, using the request data object, surrogacy criteria corresponding to the requestor information. The instructions further cause the processor to receive a plurality availability data objects, each availability data object including availability information for at least one corresponding surrogate. The instructions further cause the processor to determine, based on the surrogacy criteria and the availability information for each respective availability data object, a surrogate. The instructions further cause the processor to generate, based on the requestor information and the determined surrogate, surrogacy instructions. The instructions further cause the processor to transmit, to a surrogate device associated with the determined surrogate, a surrogacy instruction data object the surrogacy instructions.

Another aspect of the disclosed embodiments is a method for surrogacy including receiving, at a server computing device from a requestor device, a request data object including requestor information and request information. The method further includes identifying, using the request data object, surrogacy criteria corresponding to the requestor information. The method further includes receiving, at the server computing device, a plurality availability data objects, each availability data object including availability information for at least one corresponding surrogate. The method further includes determining, based on the surrogacy criteria and the availability information for each respective availability data object, a surrogate. The method further includes generating, based on the requestor information and the determined surrogate, surrogacy instructions. The method further includes transmitting, to a surrogate device associated with the determined surrogate, a surrogacy instruction data object including the surrogacy instructions.

Yet another aspect of the disclosed embodiments is a non-transitory computer-readable storage medium, comprising executable instructions that, when executed by a processor, facilitate performance of operations, including receiving, at a server computing device from a requestor device, a request data object including requestor information and request information. The instructions further cause the processor to identify, using the request data object, surrogacy criteria corresponding to the requestor information. The instructions further cause the processor to receive, at the server computing device, a plurality availability data objects, each availability data object including availability information for at least one corresponding surrogate. The instructions further cause the processor to determine, based on the surrogacy criteria and the availability information for each respective availability data object, a surrogate. The instructions further cause the processor to generate, based on the requestor information and the determined surrogate, surrogacy instructions. The instructions further cause the processor to transmit, to a surrogate device associated with the determined surrogate, a surrogacy instruction data object including the surrogacy instructions.

These and other aspects of the present disclosure are provided in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a block diagram of a system for computing according to the principles of the present disclosure.

FIG. 2 generally illustrates a block diagram of a system for surrogacy according to the principles of the present disclosure.

FIG. 3 generally illustrates a block diagram of another system for surrogacy according to aspects of the present disclosure.

FIG. 4 generally illustrates a block diagram of yet another system for surrogacy according to aspects of the present disclosure.

FIG. 5 generally illustrates a flow diagram of a method for surrogacy according to aspects of the present disclosure.

FIG. 6 generally illustrates a flow diagram of another method for surrogacy according to aspects of the present disclosure.

FIGS. 7A-7B generally illustrate a flow diagram of yet another method for surrogacy according to aspects of the present disclosure.

FIGS. 8A-AB generally illustrate a flow diagram of a further method for surrogacy according to aspects of the present disclosure.

FIG. 9 generally illustrates a flow diagram of a further method for surrogacy according to aspects of the present disclosure.

FIGS. 10A-10B generally illustrate a flow diagram of a further method for surrogacy according to aspects of the present disclosure.

FIG. 11 generally illustrates a flow diagram of a further method for surrogacy according to aspects of the present disclosure.

FIGS. 12A-12B generally illustrate a flow diagram of a further method for surrogacy according to aspects of the present disclosure.

FIG. 13 generally illustrates a flow diagram of a further method for surrogacy according to aspects of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Many purchases are made from online retailers, with products being delivered to an address selected by the purchaser. Increasingly, individuals are engaging in a number of activities, such as work, school, pet care, parenting, and the like. Periodically, an individual may have conflicting activity schedules. For example, an individual may be scheduled to attend a child's sporting event at the same time a pet is scheduled for a veterinary visit. In addition to the increasingly busier schedules of individuals, more individuals are turning to online shopping, and consequently, package delivery, for various purchases. Such increasingly busy schedules may cause the individual to be away from a delivery location at a time of delivery of a package. This may cause the package to remain unattended for a period, which may increase a likelihood of theft or damage (e.g., due to weather, animals, and the like). Periodically, a purchaser may not be available at the selected address at a time of delivery. This may result in packages being left unattended, increasing the likelihood of packages being stolen or damaged due to weather or animals, or being of a perishable nature.

Accordingly, systems and methods, such as those described herein, for identifying and securing a surrogate (e.g., a person or device, such as a drone, such a device may have capacity and authentication to stand in for the individual desiring a surrogate) for such activities and package delivery, may be desirable.

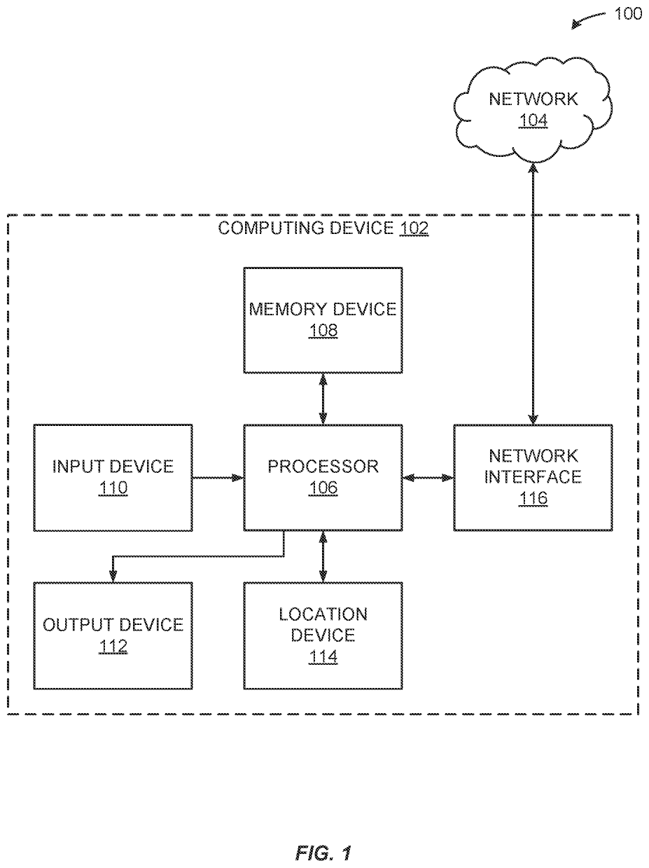

FIG. 1 generally illustrates a system 100 for computing including a computing device 102 connected to a network 104 according to the principles of the present disclosure. The computing device 102 may be configured to perform various operations and methods. The computing device 102 may include a processor 106 configured to control the overall operation of the computing device 102 and one or more memory devices 108 that may contain instructions that, when executed by the processor 106, cause the processor to perform a variety of operations. It should be understood that the processor 106 (e.g., and/or any processors described herein) may include any suitable processor, including those described herein. The memory device 108 may include Random Access Memory (RAM), a Read-Only Memory (ROM), or a combination thereof. In some embodiments, the memory device 108 may include flash memory, semiconductor (solid state) memory, a single disk or a plurality of disks (e.g., hard drives), one or more solid-state drives, or one or more hybrid hard drives.

The computing device 102 may also include an input device 110 that may be configured to receive input from an operator of the computing device 102 and to communicate signals representing the input received to the processor 106. For example, the input device 110 may include a button, keypad, dial, touch screen, audio input interface (e.g., microphone), visual/image capture input interface, input in the form of sensor data, etc.

The computing device 102 may include an output device 112 (e.g., a display screen, speaker, or any other suitable output device) that may be controlled by the processor 106 to present information to the operator. The computing device 102 may also include a location device 114 (e.g., a global positioning system (GPS) receiver configured to receive information from one or more global navigation satellite systems (GNSS), cell towers, base stations, and the like). The computing device 102 may also include a network interface 116 configured to couple or connect the computing device 102 to various other computing devices or the network 104 devices via a network connection, such as a wired or wireless connection. In some embodiments, the network interface 116 includes a wireless transceiver.

In some embodiments, the computing device 102 may include additional, fewer, or other components than those described with respect to and illustrated in FIG. 1.

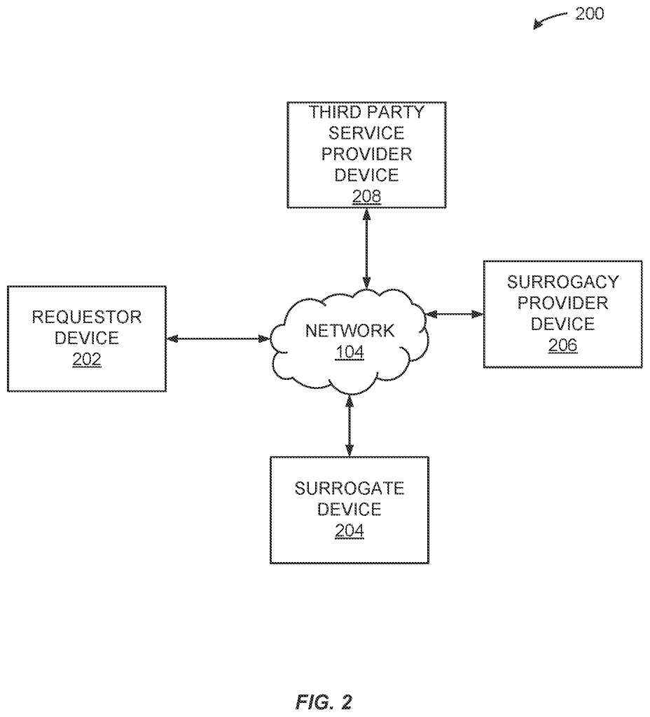

FIG. 2 generally illustrates a system 200 for providing surrogacy functions. The system 200 may include a requestor device 202, which may include a computing device such as the computing device 102 of FIG. 1, which in turn may include additional, fewer, or other components than those described with respect to and illustrated in FIG. 1. The requestor device 202 may be used by a requestor to request a surrogate to perform a task or action.

The system 200 may include a surrogate device 204, which may include a computing device such as the computing device 102 of FIG. 1, which may include additional, fewer, or other components than those described with respect to and illustrated in FIG. 1. The surrogate device 204 may be used by a surrogate to receive surrogacy instructions.

The system 200 may include a surrogacy provider device 206 (e.g., a server computing device), which in turn may include a computing device such as the computing device 102 of FIG. 1, which may include additional, fewer, or other components than those described with respect to and illustrated in FIG. 1. The surrogacy provider device 206 may perform a variety of functions, such as receiving surrogacy requests, determining a surrogate, and transmitting surrogacy instructions, as will be discussed more below.

The system 200 may include a third-party service provider device 208, which may include a computing device such as the computing device 102 of FIG. 1, which in turn may include additional, fewer, or other components than those described with respect to and illustrated in FIG. 1. The third-party service provider device 208 may be used by a third party, such as a delivery or online shopping service, involved in surrogacy operations.

In some embodiments, the system 200 may include additional, fewer, or other components than those described with respect to and illustrated in FIG. 2.

In some embodiments, the system 200 may include additional, fewer, or other components than those described with respect to and illustrated in FIG. 2. In some embodiments, the computing device(s) 102 and system 200 may perform more or fewer functions than those described above.

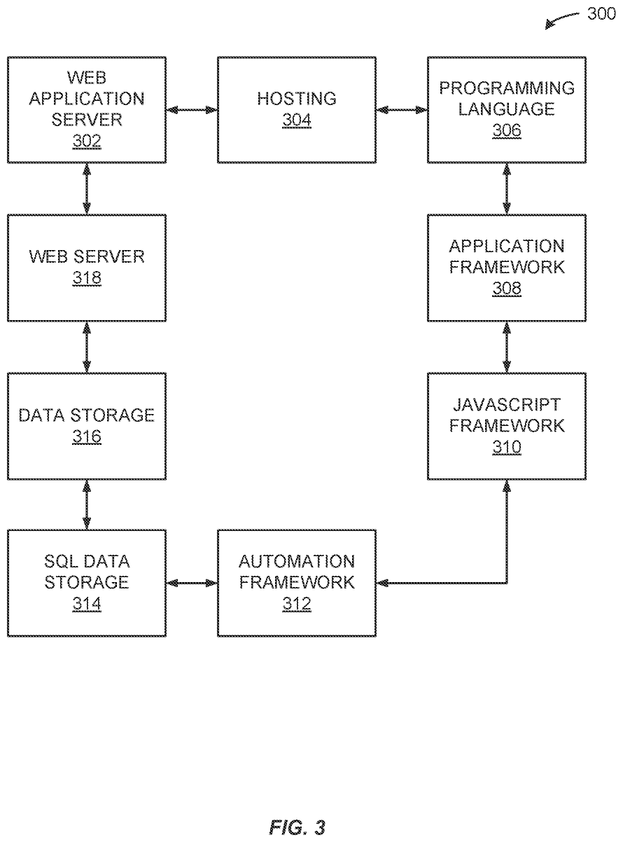

In some embodiments, a system 300 for providing surrogacy functions may include a web application server 302, as is generally illustrated in FIG. 3. The web application server 302 may include web applications enabling some or all of the functions required for surrogacy.

In some embodiments, the system 300 may include a hosting 304 service. The hosting 304 service may include applications that may be executed by a processor (e.g., according to instructions stored in a memory, such as those described herein) to provide some or all of the functions of online surrogacy, as well as data storage for one or more applications.

In some embodiments, the system 300 may be configured to process one or more programming languages 306 for allowing applications to enabling some or all of the functions of online surrogacy.

In some embodiments, the system 300 may be configured for an application framework 308, (e.g., a software library that supports applications enabling some or all of the functions of online surrogacy).

In some embodiments, the system 300 may be configured for a JavaScript framework 310 that may define one or more applications enabling some or all of the functions of online surrogacy.

In some embodiments, the system 300 may be configured for an automation framework 312 to enable automation and/or testing of one or more functions of online surrogacy. The automation framework 312 may include, for example, RSpec and Capybara.

In some embodiments, the system 300 may be configured for structured query language (SQL) data storage 314 for supporting and managing structured data.

In some embodiments, the system 300 may include data storage 316 for enabling some or all of the features of online surrogacy. The data storage 316 may include information about requestors, surrogates, third party services, shipping services, payment information, and the like.

In some embodiments, the system 300 may include a web server 318 for enabling some or all of the features of online surrogacy. The web server may transmit information, requests, and the like to and from parties including, but not limited to, requestors, surrogates, and third-party service providers.

In some embodiments, the system 300 may include additional, fewer, or other components than those described with respect to and illustrated in FIG. 3.

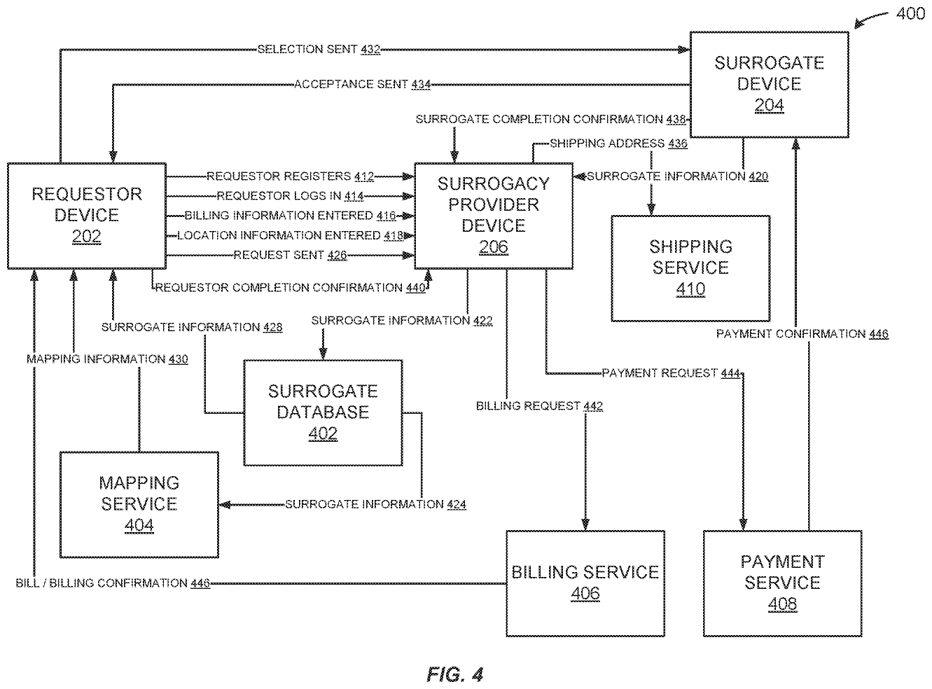

As illustrated in FIG. 4, in some embodiments, a system 400 for surrogacy is disclosed. The system 400 may include the requestor device 202, surrogate device 204, and/or the surrogacy provider device 206. The system 400 may further include a surrogate database 402 for storing surrogate information. The system 400 may further include a mapping service 404 for presenting a map to one or more of the requestor devices 202, surrogate device 204, surrogacy provider device 206, and the like. The system 400 may further include a billing service 406 for billing the requestor. The system 400 may further include a payment service 408 for initiating payment to the surrogate. The system 400 may further include a shipping service 410 for receiving and transmitting shipping information; the shipping service 410 may be configured to receive a change of shipping address and transmit signals to intercept and adjust a package being sent to redirect the package from an address of the requestor to an address of the surrogate. Any or all of the surrogate database 402, mapping service 404, billing service 406, the payment service 408, and the shipping service 410 may be integrated with the surrogacy provider device 206. The surrogacy provider device 206 itself may be integrated with the third-party service provider device 208 (e.g., a device for a company providing online sales). Any information, request, transmissions, etc. passing between different elements of the system 400 may be sent directly or indirectly by way of other elements of the system 400 or one or more networks, such as network 104, to which one or more of the elements of the system 400 are connected.

At 412, the requestor may use the requestor device 202 to register with the surrogacy provider. For example, the requestor may enter their information (e.g., picture, name, address, third party services to integrate, a username, an e-mail address, password, etc.) into the requestor device 202 by way of the input device 110 (e.g., a keyboard or touchscreen), which may then be transmitted to the surrogacy provider device 206. Location information received by way of the location device 114 may also be transmitted.

At 414, the requestor may log in to a surrogacy provider's service (e.g., through a website associated with the surrogacy provider device 206). For example, the requestor may sign in via a third-party service or using their username and address by making a selection or entering information into the requestor device 202 by way of the input device 110, which the requestor device 202 then transmits to the surrogacy provider device 206.

At 416, the requestor may enter billing information, such as bank details, credit card numbers, debit card numbers, and the like. For example, the requestor may enter credit card information into the into the requestor device 202 way of the input device 110, which the requestor device 202 then transmits to the surrogacy provider device 206.

At 418, the requestor may enter a zip code or other geographic information, such as a street address. For example, the requestor may enter their address into the requestor device 202 by way of the input device 110, which the requestor device 202 then transmits to the surrogacy provider device 206.

At 420, the surrogate device 204 may transmit surrogate information about the surrogate. For example, the surrogate may enter their information (e.g., picture, name, address, third party services to integrate, a username, an e-mail address, password, timeslots available, freezer space available, refrigerator space available, certifications, animals they are comfortable working with, etc.) into the surrogate device 204 by way of the input device 110 (e.g., a keyboard or touchscreen), which may then be transmitted to the surrogacy provider device 206.

At 422, the surrogate information may be transmitted from the surrogacy provider device 206 to the surrogate database 402. For example, the network interface 116 of the surrogacy provider device 206 may transmit the surrogate information to the surrogate database.

At 424, the surrogate information may be transmitted from the surrogate database 402 to the mapping service 404.

At 426, the requestor device 202 may transmit a request for surrogacy. The request for surrogacy may be based on an individual request for surrogacy made by the requestor. For example, the requestor may make a request for surrogacy by making a selection or entering information into the requestor device 202 by way of the input device 110, which the requestor device 202 then transmits to the surrogacy provider device 206. The request for surrogacy may be based on a request by a third-party service provider having information about the requestor' s availability; in such cases, the request may be transmitted from a device different from the requestor device 202.

At 428, the surrogacy provider device 206 may, after determining surrogate availability information, cause the surrogate database 402 to transmit surrogate information about the available surrogates to the requestor device 202, which the requestor may view by way of the output device 112.

At 430, the surrogacy provider device 206 may, after determining surrogate availability information, cause the mapping service 404 to transmit mapping information and/or surrogate information about the available surrogates to the requestor device 202, which the requestor may view by way of the output device 112.

At 432, the requestor device 202 may, based on a selection by the requestor, transmit a selection of a surrogate to the surrogate device 204. The selection may be transmitted by way of the surrogacy provider device 206, which may itself transmit the selection to the surrogate device 204.

At 434, the surrogate device 204 may, based on a selection by the surrogate, transmit an acceptance to the requestor device 202. The acceptance may be transmitted by way of the surrogacy provider device 206, which may itself transmit the selection to the requestor device 202.

At 436, in cases where the surrogacy service requested is package reception, the surrogacy provider device 206 may transmit a shipping address based on the surrogate's address to the shipping service 410, allowing for the shipping service 410 to change the delivery address for the package. In some embodiments, a surrogate may be selected automatically based on a failure to deliver in-person to the requestor, and the shipping company will deliver the package to the surrogate.

At 438, the surrogate device 204 may, based on input by the surrogate, transmit a surrogate completion confirmation to the surrogacy provider device 206.

At 440, the requestor device 202 may, based on an input by the requestor, transmit a requestor completion confirmation to the surrogacy provider device 206.

At 442, the surrogacy provider device 206 may, based on the surrogate completion confirmation and/or the requestor completion confirmation, transmit a billing request to the billing service 406.

At 444, the surrogacy provider device 206 may, based on the surrogate completion confirmation and/or the requestor completion confirmation, transmit a payment request to the payment service 408.

At 446, the billing service 406 may, based on the billing request, transmit a bill and/or billing confirmation to the requestor device 202. The billing request may be greater than the payment request, such that the payment service provider receives a portion of the payment.

At 448, the payment service 408 may, based on the payment request, cause a payment to be made to the surrogate and/or send a payment confirmation to the surrogate device 204.

In some embodiments, the system 400 may include additional, fewer, or other components, than those described with respect to and illustrated in FIG. 4. In some embodiments, the system 400 may perform more or fewer functions than those described above.

In some embodiments one or more of the systems 100, 200, 300, 400 or combinations of the systems 100, 200, 300, 400 or components thereof may perform one or more functions.

The requestor device 202 may transmit, and the surrogacy provider device 206 may receive, requestor information. Requestor information may include the requestor's anticipated service location or delivery location, information about the requestor's schedule, payment information for the requestor, a verified or unverified ID .

The requestor device 202 may transmit, and the surrogacy provider device 206 may receive, request information. Request information may be received from a third-party service provider, such as a shipping company (e.g., a postal service) or a store (e.g., a grocery store). Request information may be based on the requestor information. Request information may include information about a service to be performed, such as package reception, plant care, childcare, elderly care, disabled person care, pet care, and the like. Request information may include a location, such as a specified location that the requestor may wish to eventually move a package to (i.e., the requestor could have a surrogate receive the package, which the requestor could pick up and move to the specified location; such information may be valuable by allowing the requestor to pick up the package close to the requestor' s specified location. Request information may include a planned or expected driving route (i.e., the requestor could have the surrogate receive the package, which the requestor could pick up on their way to another location, like home; it may be less disruptive to the requestor or other parties. Request information may include a service time, such as a delivery window. Request information may include a pickup time for a package. Request information may include whether packages (e.g., groceries) need to be refrigerated or frozen. Request information may include requestor schedule information; requestor schedule information may be used to determine whether a service is required. Request information may include care information (e.g., information about an object, such as a plant, or person, such as a child, an elderly person, a disabled person, a pet, or the like that need to be monitored (and/or cared for and what services may or will be required as a part of that care). Request information may include an expected time for the service, expected duration of the service, probability that the service be extended, and the like.

The processor 106 of the surrogacy provider device 206 may determine, based on the requestor information and the request information, whether surrogacy is required. For example, if comparing requestor information including the requestor's schedule with request information including the expected delivery time, it may be determined that surrogacy is not required. This may be useful in cases where surrogacy is integrated with a third-party service, such as a shipping or shopping service, and the request information comes from third party service.

The processor 106 of the surrogacy provider device 206 may receive surrogate information from the surrogate device 204. The surrogate information may be received from surrogates, a third party, or storage based on prior services provided by the surrogate. The surrogate information may include the surrogate's name, address, a verified photo ID, drop-off windows, pickup windows, prior performance ratings, payment reception information (e.g., bank account or payment service details), criminal background information, certifications (e.g., childcare, plant care, medical care, etc.), refrigerator and freezer availability, schedule (e.g., for delivery and pickup), and the like.

The processor 106 of the surrogacy provider device 206 may, based on the surrogate information and the request information, determine surrogate availability information. For example, determining the surrogate availability information may include comparing expected service time (e.g., delivery time and pickup time, etc.) to the schedule of the surrogates. Determining the surrogate availability information may include comparing the service required with certifications of the surrogates (e.g., if a child needs to be monitored or cared for, determining whether any of the available surrogates have any form of certifications). The surrogate availability information may include names, addresses, availability windows, certifications, distance from specified location, distance from the planned or expected driving route, ability to hold perishable items, ability to hold large items, ability to hold heavy items, availability of a driveway for parking, quantity of pets owned if any, availability for scheduled and unscheduled holds, and the like of surrogates.

The processor 106 of the surrogacy provider device 206 may cause some or all of the surrogate availability information to be presented on the output device 112 of the requestor device 202. Some information may not be presented for the sake of the one or more surrogates' privacy. For example, cross streets may be displayed, but street addresses may not. In some embodiments, the surrogate availability information may be presented on a map to allow for selection of the surrogate by the requestor based on the location of the surrogates. In some embodiments, the surrogate availability information appears in a grid and may be organized based on proximity to the requestor's address or travel route.

The processor 106 of the surrogacy provider device 206 may receive a surrogate selection from the requestor entered via the input device 110 of the requestor device 202 from the requestor device 202. The surrogate selection may include one or more surrogates selected by the requestor.

The processor 106 of the surrogacy provider device 206 may transmit one or more surrogacy requests to one or more surrogate devices 204 and cause the surrogacy requests or a representation thereof to be presented on respective output devices 112 of the one or more surrogate devices 204. The surrogacy requests may include information about the requestor and the requestor's needs. Some information associated with the requestor (e.g., age, street address, etc.) may not be transmitted or presented for the sake of the requestor's privacy.

One or more surrogates may indicate their acceptance via respective input devices 110 of respective surrogate devices 204, and the respective surrogate devices may transmit surrogacy acceptance indicators to the surrogacy provider device 206, which receives the surrogacy acceptance indicators.

The processor 106 of the surrogacy provider device 206 may determine selected surrogate, selected surrogate information, and/or surrogacy instructions. Determining the selected surrogate, selected surrogate information, and/or surrogacy instructions may be based on one or more of the requestor information, request information, the surrogate selection, and the surrogacy acceptance indicators. The surrogacy instructions may include requestor contact information. The surrogacy contact information may be anonymized contact information (e.g., a phone number provided by a surrogacy provider or a third-party service provider that acts as an intermediary between the requestor and the surrogate). The surrogacy instructions may include time of drop-off, time of pick-up, storage requirements (e.g., refrigerator or freezer), number of pets, pet care instructions, number of plants, plant care instructions, number of children, childcare, check-in instructions, number of seniors, senior care instructions, and the like.

The processor 106 of the surrogacy provider device 206 may cause some or all of the selected surrogate information to be presented on the output device 112 of the requestor device 202. The selected surrogate information may include surrogate contact information. The surrogate contact information may be anonymized contact information (e.g., a phone number provided by a surrogacy provider or a third-party service provider that acts as an intermediary between the requestor and the surrogate).

The processor 106 of the surrogacy provider device 206 may cause surrogacy instructions to be presented on the output device 112 of the surrogate device 204.

The requestor may input a surrogacy extension request via the input device 110 of the requestor device 202, which the requestor device 202 may transmit for the surrogacy provider device 206 to receive. The surrogacy extension request may be received from the requestor (e.g., the requestor will be late and their child may need to be cared for over a longer period of time than was initially agreed upon).

The processor 106 of the surrogacy provider device 206 may transmit the surrogacy extension request to the surrogate device 204 and cause the surrogacy extension request to be displayed on the output device 112 of the surrogate device 204.

The processor 106 of the surrogacy provider device 206 may receive an extension request decision entered via the input device 110 of the surrogate device 204 from the surrogate device.

The processor 106 of the surrogacy provider device 206 may receive a surrogacy end data object including a surrogacy end indicator indicating that the surrogacy task is complete. The surrogacy end data object may be received from the surrogate (i.e., from the surrogate device 204). The surrogacy end data object may be received from the requestor (i.e., from the requestor device 202).

The processor 106 of the surrogacy provider device 206 may receive a surrogate performance rating indicator input by way of the input device 110 of the requestor device 202 from the requestor device 202. The surrogate performance rating may be one or more ratings covering areas such as requestor responsiveness, requestor timeliness, requestor politeness, etc.

The processor 106 of the surrogacy provider device 206 may receive a requestor performance rating indicator input by way of the input device 110 of the surrogate device 204 from the surrogate device 204. The requestor performance rating may be one or more ratings covering areas such as surrogate availability, surrogate timeliness, surrogate politeness, etc.

In some embodiments one or more of the systems 100, 200, 300, 400 or combinations of the systems 100, 200, 300, 400 or components thereof may perform one or more functions.

The processor 106 of the surrogacy provider device 206 may receive a request data object from the requestor device 202. The request data object may include requestor location. In some embodiments, the request data object may include storage requirements. In some embodiments, the storage requirements may include cold storage requirements. In some embodiments, the request data object may include pet monitoring. In some embodiments, the request data object may include child or senior monitoring. In some embodiments, the request data object may include package delivery. In some embodiments, the request data object may include grocery delivery.

The processor 106 of the surrogacy provider device 206 may identify, based on the request data object, the surrogacy criteria. In some embodiments, the surrogacy criteria includes physical proximity between the requestor location and the surrogate location. In some embodiments, the surrogacy criteria may include the storage requirements. In some embodiments, the surrogacy criteria includes the cold storage requirements.

The processor 106 of the surrogacy provider device 206 may receive one or more availability data objects including availability information for at least one corresponding surrogate from the surrogate device 204 or the surrogate database 402. In some embodiments, the availability information may include a surrogate location. In some embodiments, the availability information may include surrogate storage availability. In some embodiments, the surrogate storage availability includes cold storage availability.

The processor 106 of the surrogacy provider device 206 may transmit at least a portion of the availability information to the requestor device 202.

The processor 106 of the surrogacy provider device 206 may cause at least a portion of the transmitted portion of the availability information to be presented on the requestor device 202.

The processor 106 of the surrogacy provider device 206 may receive a surrogate selection from the requestor device 202. In some embodiments, the surrogacy criteria includes the surrogate selection.

The processor 106 of the surrogacy provider device 206 may determine, based on the surrogacy criteria, a surrogate.

The processor 106 of the surrogacy provider device 206 may determine, based on the surrogacy criteria, surrogacy instructions.

The processor 106 of the surrogacy provider device 206 may transmit a surrogacy instruction data object including the surrogacy instructions to the surrogate device 204.

The processor 106 of the surrogacy provider device 206 may receive a surrogacy end data object including a surrogacy end indicator indicating that the surrogacy has ended from one or both of the requestor device 202 and the surrogate device 204.

In some embodiments, the systems 100, 200, 300, 400, and combinations thereof may include additional, fewer, or other components, than those described with respect to and illustrated in FIGS. 1-4. In some embodiments, the systems 100, 200, 300, 400, and combinations thereof may perform more or fewer functions than those described above.

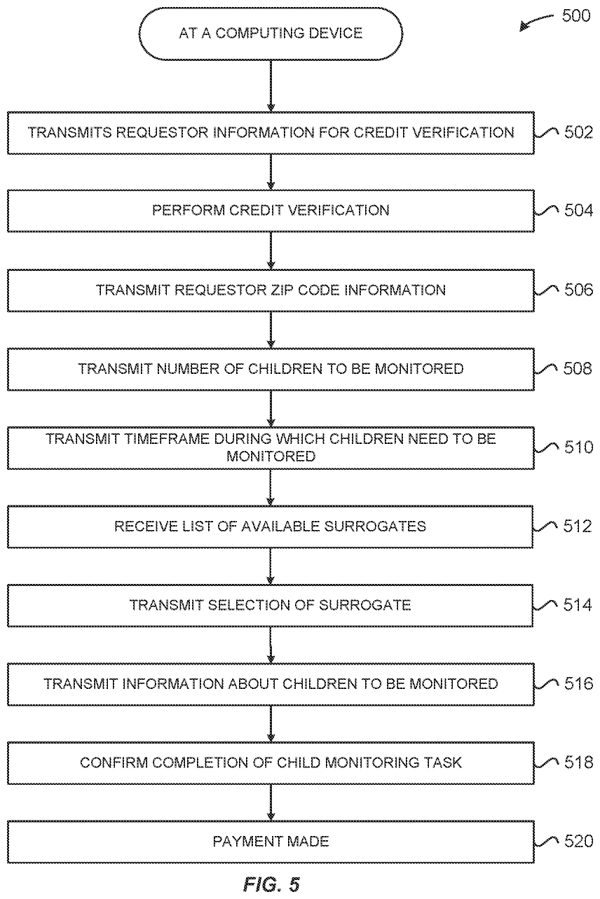

As illustrated in FIG. 5, in some embodiments, a method 500 for surrogacy involving child monitoring is disclosed. In some embodiments, instructions are stored on a memory device that, when executed by a processor, cause the processor to perform the steps of method 500.

At 502, a requestor may transmit requestor information for credit verification (for example, to allow confidence on the part of the surrogacy provider and surrogate when using an automatic payment feature). The requestor information for credit verification may be transmitted from the requestor device 202 to the surrogacy provider device 206.

At 504, credit verification may be performed based on the requestor information for credit verification. The surrogacy provider device 206 may perform the verification by, for example, transmitting the requestor information for credit verification to a credit agency or the billing service 406 and receiving a response therefrom.

At 506, the requestor may transmit requestor zip code information. The requestor zip code information may be transmitted by the requestor device 202 to the surrogacy provider device 206.

At 508, the requestor may transmit a number of children to be monitored. The number of children to be monitored may be transmitted by the requestor device 202 to the surrogacy provider device 206.

At 510, the requestor may transmit a timeframe during which the children need to be monitored. The timeframe during which the children need to be monitored may be transmitted by the requestor device 202 to the surrogacy provider device 206.

At 512, the requestor may receive a list of available surrogates. The list of available surrogates may be received by the requestor device 202 from the surrogacy provider device 206. The surrogacy provider device 206 may first determine the list of available surrogates based on the zip code of the requestor and/or other information (e.g., address, surrogacy requirements, etc.) provided by the requestor.

At 514, the requestor may transmit a selection of a surrogate. The selection of the surrogate may be transmitted by the requestor device 202 to the surrogacy provider device 206. The surrogate may then accept the request. For example, the surrogate device 204 may transmit the acceptance to the requestor device 202 by way of the surrogacy provider device 206.

At 516, the requestor may transmit information about one or more children to be monitored. The information about one or more children to be monitored may be transmitted directly from the requestor device 202 to the surrogate device 204 or be transmitted by way of the surrogacy provider device 206. The information may include one or more e-mail addresses associated with the one or more children. In such cases, the surrogate's task may be to check in via e-mail or other means with the one or more children over a period determined by the requestor. In some embodiments, this check-in may be accomplished through an application associated with the surrogacy provider and the surrogacy provider device 206. In some embodiments, the surrogate may be required to monitor the children onsite and provide updates to the requestor in a certain period of time

At 518, the requestor may confirm completion of the child monitoring task. The requestor device 202 may transmit the confirmation to the surrogacy provider device 206.

At 520, the requestor may be required to make a payment. The payment may occur some period of time after a task is confirmed to be completed. The payment may occur in increments if the task is a multi-day task. The requestor may be required to pay more for certain tasks (e.g., onsite monitoring) or during certain timeframes (e.g., between the hours of midnight and 6:00 AM). The surrogate may receive payments once the requestor has made the payment. The surrogate may receive one or more payments over certain time increments, such as weekly, bi-weekly, or monthly. The surrogacy provider may take a certain percentage of the payment received from the requestor.

It should be understood that a variety of child monitoring tasks are contemplated within the method 500. For example, the surrogate may be required to send a code or e-mail the one or more children every 15 minutes and notify the requestor of a response or non-response from one or more of the one or more children within five minutes of e-mailing the one or more children.

The method 500 may include more or fewer steps than those described above, and the steps of method 500 may be performed in any suitable order.

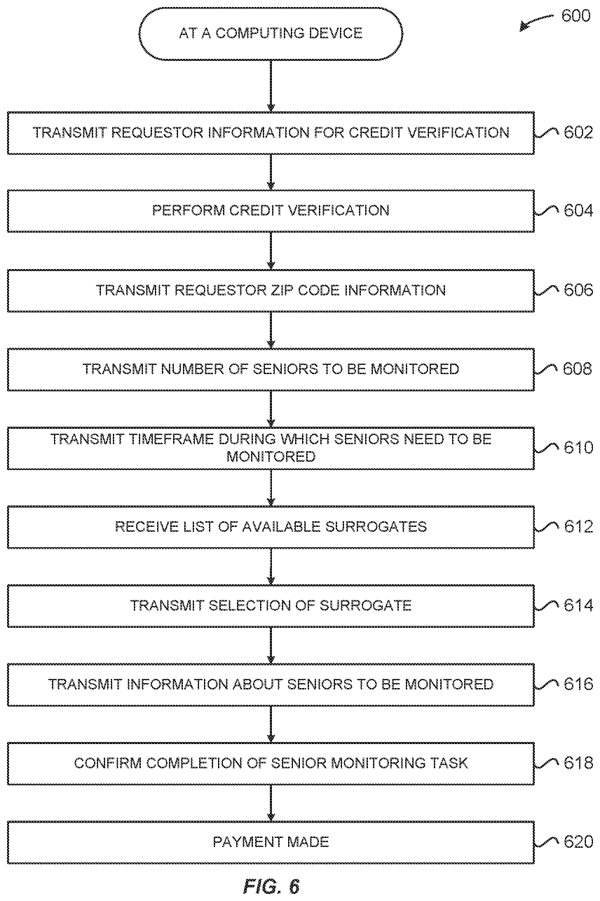

As illustrated in FIG. 6, in some embodiments, a method 600 for surrogacy involving senior monitoring is disclosed. In some embodiments, instructions are stored on a memory device that, when executed by a processor, cause the processor to perform the steps of method 600.

At 602, a requestor may transmit requestor information for credit verification (for example, to allow confidence on the part of the surrogacy provider and surrogate when using an automatic payment feature). The requestor information for credit verification may be transmitted from the requestor device 202 to the surrogacy provider device 206.

At 604, credit verification may be performed based on the requestor information for credit verification. The surrogacy provider device 206 may perform the verification by, for example, transmitting the requestor information for credit verification to a credit agency or the billing service 406 and receiving a response therefrom.

At 606, the requestor may transmit requestor zip code information. The requestor zip code information may be transmitted by the requestor device 202 to the surrogacy provider device 206.

At 608, the requestor may transmit a number of seniors to be monitored. The number of seniors to be monitored may be transmitted by the requestor device 202 to the surrogacy provider device 206.

At 610, the requestor may transmit a timeframe during which the seniors need to be monitored. The timeframe during which the seniors need to be monitored may be transmitted by the requestor device 202 to the surrogacy provider device 206.

At 612, the requestor may receive a list of available surrogates. The list of available surrogates may be received by the requestor device 202 from the surrogacy provider device 206. The surrogacy provider device 206 may first determine the list of available surrogates based on the zip code of the requestor and/or other information (e.g., address, surrogacy requirements, etc.) provided by the requestor.

At 614, the requestor may transmit a selection of a surrogate. The selection of the surrogate may be transmitted by the requestor device 202 to the surrogacy provider device 206. The surrogate may then accept the request. For example, the surrogate device 204 may transmit the acceptance to the requestor device 202 by way of the surrogacy provider device 206.

At 616, the requestor may transmit information about one or more seniors to be monitored. The information about one or more seniors to be monitored may be transmitted directly from the requestor device 202 to the surrogate device 204 or be transmitted by way of the surrogacy provider device 206. The information may include one or more e-mail addresses associated with the one or more seniors. In such cases, the surrogate's task may be to check in via code or e-mail with the one or more seniors over a period determined by the requestor. In some embodiments, this check-in may be accomplished through an application associated with the surrogacy provider and the surrogacy provider device 206. In some embodiments, the surrogate may be required to monitor the one or more seniors onsite and provide updates to the requestor in a certain period of time.

At 618, the requestor may confirm completion of the senior monitoring task. The requestor device 202 may transmit the confirmation to the surrogacy provider device 206.

At 620, the requestor may be required to make a payment. The payment may occur some period of time after a task is confirmed to be completed. The payment may occur in increments if the task is a multi-day task. The requestor may be required to pay more for certain tasks (e.g., onsite monitoring) or during certain timeframes (e.g., between the hours of midnight and 6:00 AM). The surrogate may receive payments once the requestor has made the payment. The surrogate may receive one or more payments over certain time increments, such as weekly, bi-weekly, or monthly. The surrogacy provider may take a certain percentage of the payment received from the requestor.

It should be understood that a variety of senior monitoring tasks are contemplated within the method 600. For example, the surrogate may be required to contact via e-mail or other means the one or more seniors every 15 minutes and notify the requestor of a response or non-response from one or more of the one or more seniors within five minutes of e-mailing the one or more seniors.

The method 600 may include more or fewer steps than those described above, and the steps of method 600 may be performed in any suitable order. It should be noted that the methods 500, 600 of FIGS. 5 and 6 may be applied to groups other than children and seniors (e.g., the physically disabled, mentally disabled, people suffering depression, etc.).

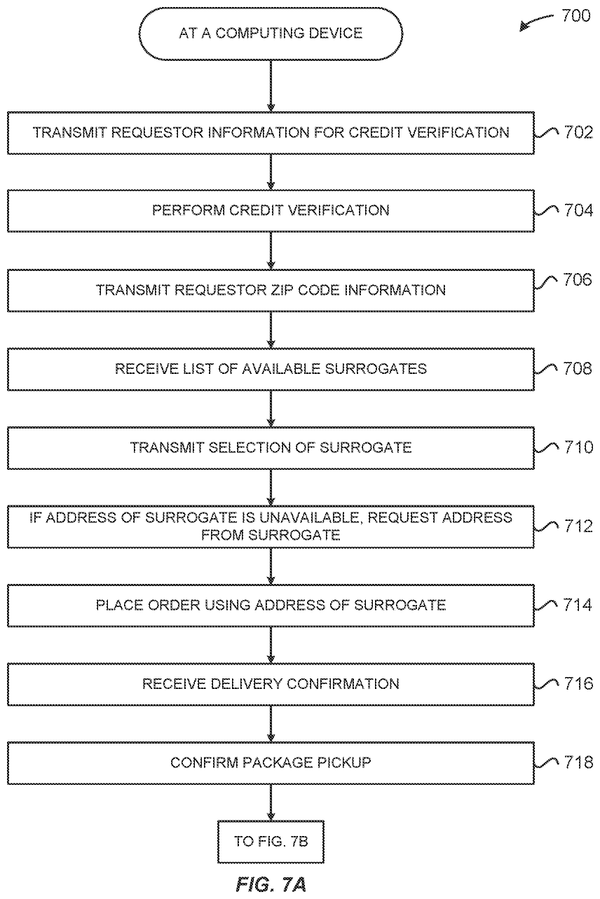

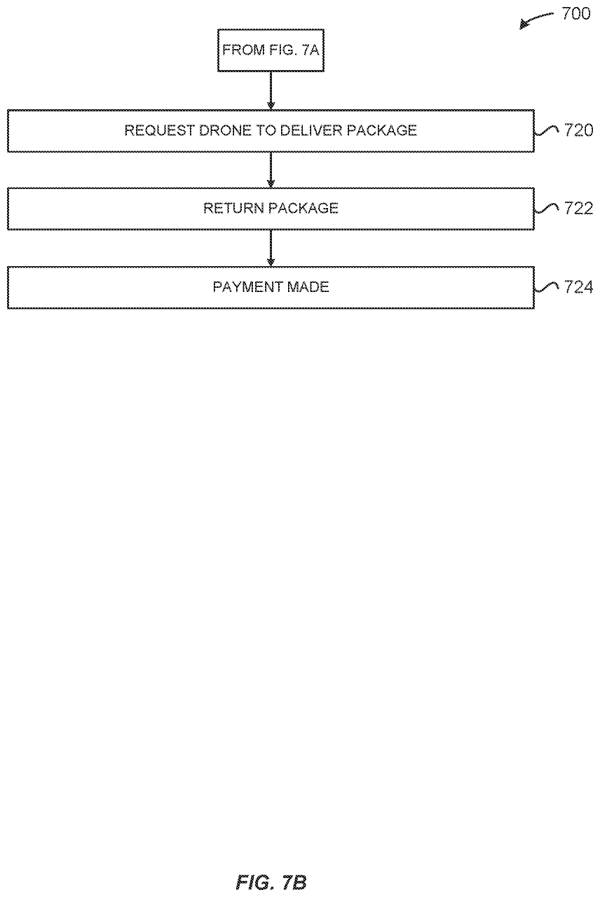

As illustrated in FIGS. 7A-7B, in some embodiments, a method 700 for surrogacy that may involve drone and/or otherwise automated delivery is disclosed. In some embodiments, instructions are stored on a memory device that, when executed by a processor, cause the processor to perform the steps of method 700.

At 702, a requestor may transmit requestor information for credit verification (for example, to allow confidence on the part of the surrogacy provider and surrogate when using an automatic payment feature). The requestor information for credit verification may be transmitted from the requestor device 202 to the surrogacy provider device 206.

At 704, credit verification may be performed based on the requestor information for credit verification. The surrogacy provider device 206 may perform the verification by, for example, transmitting the requestor information for credit verification to a credit agency or the billing service 406 and receiving a response therefrom.

At 706, the requestor may transmit requestor zip code information. The requestor zip code information may be transmitted by the requestor device 202 to the surrogacy provider device 206.

At 708, the requestor may receive a list of available surrogates. The list of available surrogates may be received by the requestor device 202 from the surrogacy provider device 206. The surrogacy provider device 206 may first determine the list of available surrogates based on the zip code of the requestor and/or other information (e.g., address, surrogacy requirements, etc.) provided by the requestor.

At 710, the requestor may transmit a selection of a surrogate. The selection of the surrogate may be transmitted by the requestor device 202 to the surrogacy provider device 206. The surrogate may then accept the request. For example, the surrogate device 204 may transmit the acceptance to the requestor device 202 by way of the surrogacy provider device 206.

At 712, the requestor may contact the surrogate to receive an address from the surrogate if the surrogate is available. The contact to the surrogate may occur between the requestor device 202 and the surrogate device 204; this may occur by way of the surrogacy provider device 206.

At 714, the requestor may place an order using the address of the surrogate. This may occur directly, with the requestor entering the address of the surrogate (e.g., the requestor enters the address via the input device 110 of the requestor device 202), or indirectly (e.g., the requestor device 202 transmits a request data object to the surrogacy provider device 206, which places the order at a third-party service provider (e.g., an online shopping service)).

At 716, once the package has been delivered, the requestor may receive a delivery confirmation. The delivery confirmation may be received by the requestor device 202 from one or more of the surrogate device 204, the surrogacy provider device 206, the third party service provider device 208, or any other suitable device, with the confirmation being provided by the surrogate, the surrogacy provider, the third party service provider, or any other suitable party (e.g., the shipping company).

At 718, the requestor may confirm they have picked up the package. For example, the requestor device 202 may transmit the confirmation to the surrogacy provider device 206.

At 720, if the requestor has not picked the package, the requestor, surrogate, or surrogacy provider may request for a drone or some other form of automated delivery service to deliver the package from the surrogate to the requestor. The request for a drone to deliver the package may be transmitted, for example, from the requestor device 202 to the surrogacy provider device.

At 722, if the requestor has not picked up the package and a drone has not delivered the package to the requestor, the surrogate may be directed to return the package. For example, the surrogacy provider device 206 may transmit instructions to the surrogate device 204 instructing the surrogate to print out a shipping return label, place the shipping return label on the package, and take the package to a shipping site (e.g., a post office or a store for a shipping service).

At 724, the requestor may be required to make a payment. The payment may occur some period of time after the package has been delivered to the surrogate, after the package has been picked up by the requestor, after the package has been delivered by drone to the requestor, or after the surrogate has returned the package. The requestor may be required to pay more if certain events occur (e.g., a drone delivery is required or the surrogate has to return the package). The surrogate may receive payments once the requestor has made the payment. The surrogate may receive one or more payments over certain time increments, such as weekly, bi-weekly, or monthly. The surrogacy provider may take a certain percentage of the payment received from the requestor.

The method 700 may include more or fewer steps than those described above, and the steps of method 700 may be performed in any suitable order.

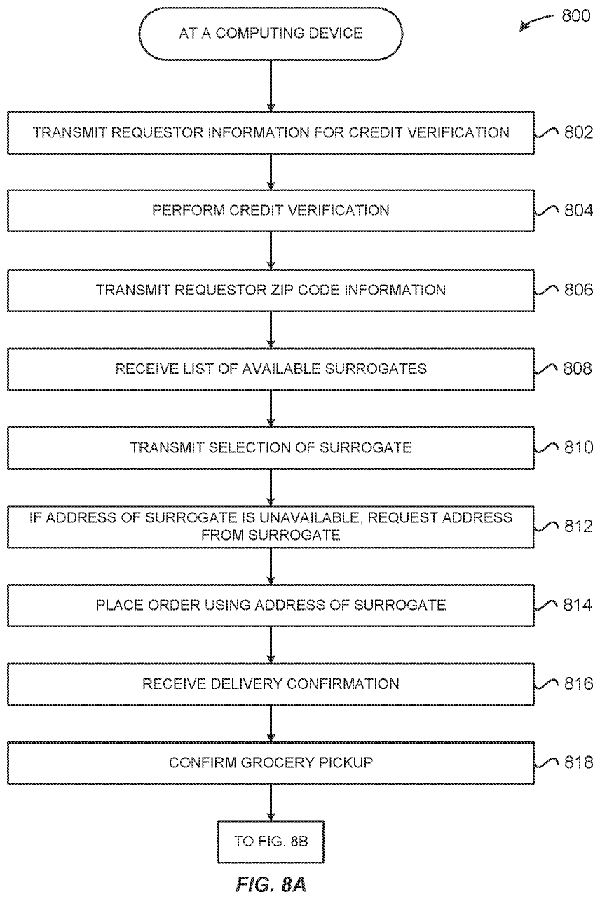

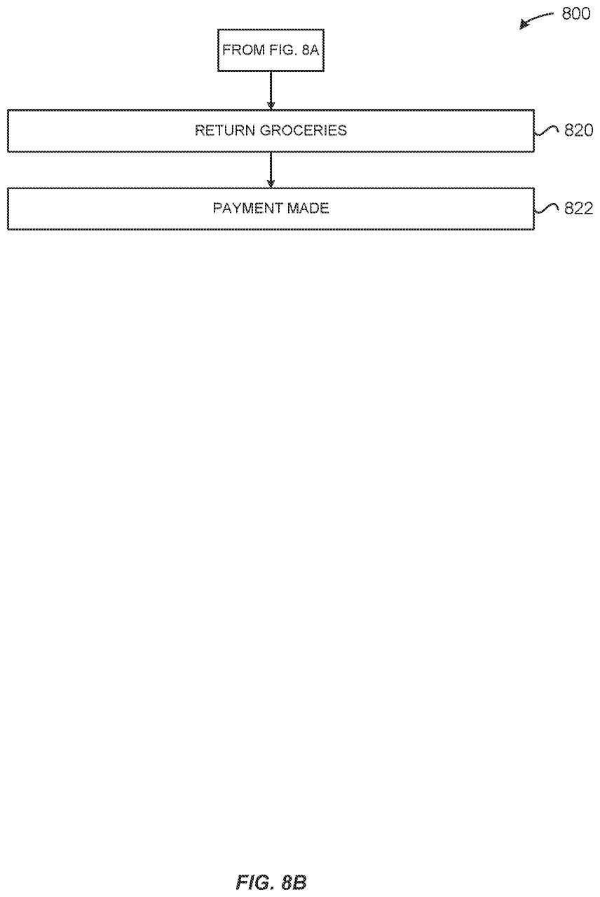

As illustrated in FIGS. 8A-8B, in some embodiments, a method 800 for surrogacy involving receiving grocery delivery is disclosed. In some embodiments, instructions are stored on a memory device that, when executed by a processor, cause the processor to perform the steps of method 800.

At 802, a requestor may transmit requestor information for credit verification (for example, to allow confidence on the part of the surrogacy provider and surrogate when using an automatic payment feature). The requestor information for credit verification may be transmitted from the requestor device 202 to the surrogacy provider device 206.

At 804, credit verification may be performed based on the requestor information for credit verification. The surrogacy provider device 206 may perform the verification by, for example, transmitting the requestor information for credit verification to a credit agency or the billing service 406 and receiving a response therefrom.

At 806, the requestor may transmit requestor zip code information. The requestor zip code information may be transmitted by the requestor device 202 to the surrogacy provider device 206.

At 808, the requestor may receive a list of available surrogates. The list of available surrogates may be received by the requestor device 202 from the surrogacy provider device 206. The surrogacy provider device 206 may first determine the list of available surrogates based on the zip code of the requestor and/or other information (e.g., address, surrogacy requirements, etc.) provided by the requestor. The list of available surrogates may include available freezer and/or refrigerator space.

At 810, the requestor may transmit a selection of a surrogate. The selection of the surrogate may be transmitted by the requestor device 202 to the surrogacy provider device 206. The surrogate may then accept the request. For example, the surrogate device 204 may transmit the acceptance to the requestor device 202 by way of the surrogacy provider device 206.

At 812, the requestor may contact the surrogate to receive an address from the surrogate if the surrogate is available. The contact to the surrogate may occur between the requestor device 202 and the surrogate device 204; this may occur by way of the surrogacy provider device 206.

At 814, the requestor may place an order using the address of the surrogate. This may occur directly, with the requestor entering the address of the surrogate (e.g., the requestor enters the address via the input device 110 of the requestor device 202), or indirectly (e.g., the requestor device 202 transmits a request data object to the surrogacy provider device 206, which places the order at a third-party service provider (e.g., an online shopping service)).

At 816, once the groceries have been delivered, the requestor may receive a delivery confirmation. The delivery confirmation may be received by the requestor device 202 from one or more of the surrogate device 204, the surrogacy provider device 206, the third party service provider device 208, or any other suitable device, with the confirmation being provided by the surrogate, the surrogacy provider, the third party service provider, or any other suitable party (e.g., the shipping company or delivery service for groceries or the like).

At 818, the requestor may confirm they have picked up the groceries. For example, the requestor device 202 may transmit the confirmation to the surrogacy provider device 206.

At 820, if the requestor has not picked up the groceries, the surrogate may be directed to return the groceries. For example, the surrogacy provider device 206 may transmit instructions to the surrogate device 204 instructing the surrogate to print out a shipping return label, place the shipping return label on the groceries, and take the groceries to a shipping site (e.g., a post office or a store for a shipping service). Alternatively, the surrogate may be instructed to take the groceries back to the site the groceries originated from and return them.

At 822, the requestor may be required to make a payment. The payment may occur some period of time after the groceries have been delivered to the surrogate, after the groceries have been picked up by the requestor, or after the surrogate has returned the groceries. The requestor may be required to pay more if certain events occur (e.g., the surrogate has to return the groceries). The surrogate may receive payments once the requestor has made the payment. The surrogate may receive one or more payments over certain time increments, such as weekly, bi-weekly, or monthly. The surrogacy provider may take a certain percentage of the payment received from the requestor.

The method 800 may include more or fewer steps than those described above, and the steps of method 800 may be performed in any suitable order.

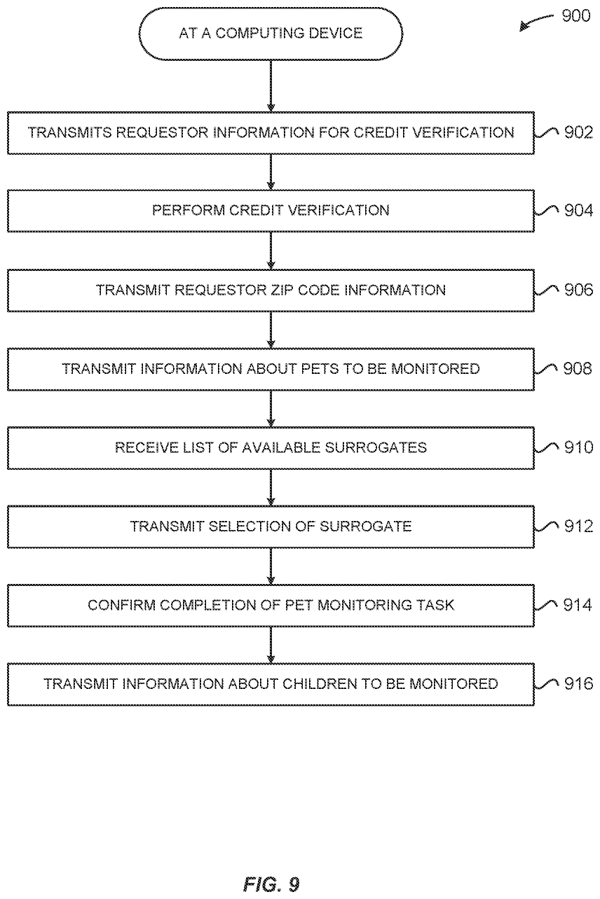

As illustrated in FIG. 9, in some embodiments, a method 900 for surrogacy involving pet monitoring is disclosed. In some embodiments, instructions are stored on a memory device that, when executed by a processor, cause the processor to perform the steps of method 900.

At 902, a requestor may transmit requestor information for credit verification (for example, to allow confidence on the part of the surrogacy provider and surrogate when using an automatic payment feature). The requestor information for credit verification may be transmitted from the requestor device 202 to the surrogacy provider device 206.

At 904, credit verification may be performed based on the requestor information for credit verification. The surrogacy provider device 206 may perform the verification by, for example, transmitting the requestor information for credit verification to a credit agency or the billing service 406 and receiving a response therefrom.

At 906, the requestor may transmit requestor zip code information. The requestor zip code information may be transmitted by the requestor device 202 to the surrogacy provider device 206.

At 908, the requestor may transmit information about one or more pets to be monitored. This information may include the number of pets to be monitored, timeframe in which the pets are to be monitored, names of pets to be monitored, types of pets to be monitored (e.g., dogs, cats, fish, rats, ferrets, birds, etc.), breeds of pets to be monitored, ages of pets to be monitored, sizes of pets to be monitored, medical requirements (e.g., what medicines, at what times of day, how often, etc.) of pets to be monitored, feeding requirements (what foods, at what times of day, how often, etc.) of pets to be monitored, yard requirements of pets to be monitored, exercise requirements of pets to be monitored, allergies of pets to be monitored, whether the pets are to be monitored at the requestor's address or the surrogate's address, the pet's veterinarian name and number, what shots the pet had and when the pet hand them, things that may cause anxiety or other poor reactions in the pet, barking or noise level, if the pet is house trained, etc.), and the like. This information may be transmitted by the requestor device 202 to the surrogacy provider device 206.

At 910, the requestor may receive a list of available surrogates. The list of available surrogates may be received by the requestor device 202 from the surrogacy provider device 206. This may include further surrogate information, such as experience, certifications, names, addresses, other pets owned and details thereof (e.g., what animals the surrogate's pets do and do not get along with, what food may be in dishes nearby that the requestor's pets may be exposed to, etc.), surrogate's pets' allergies, surrogate's allergies, surrogate's yard size, crate availability, and the like. The surrogacy provider device 206 may first determine the list of available surrogates based on the zip code of the requestor and/or other information (e.g., address, surrogacy requirements, etc.) provided by the requestor.

At 912, the requestor may transmit a selection of a surrogate. The selection of the surrogate may be transmitted by the requestor device 202 to the surrogacy provider device 206. The surrogate may then accept the request. For example, the surrogate device 204 may transmit the acceptance to the requestor device 202 by way of the surrogacy provider device 206.

At 914, the requestor may confirm completion of the pet monitoring task. The requestor device 202 may transmit the confirmation to the surrogacy provider device 206.

At 916, the requestor may be required to make a payment. The payment may occur some period of time after a task is confirmed to be completed. The payment may occur in increments if the task is a multi-day task. The requestor may be required to pay more for certain tasks (e.g., onsite monitoring) or during certain timeframes (e.g., between the hours of midnight and 6:00 AM). The surrogate may receive payments once the requestor has made the payment. The surrogate may receive one or more payments over certain time increments, such as weekly, bi-weekly, or monthly. The surrogacy provider may take a certain percentage of the payment received from the requestor.

It should be understood that a variety of pet monitoring tasks are contemplated within the method 900. For example, the surrogate may be required to provide updates at certain increments to the requestor.

The method 900 may include more or fewer steps than those described above, and the steps of method 900 may be performed in any suitable order.

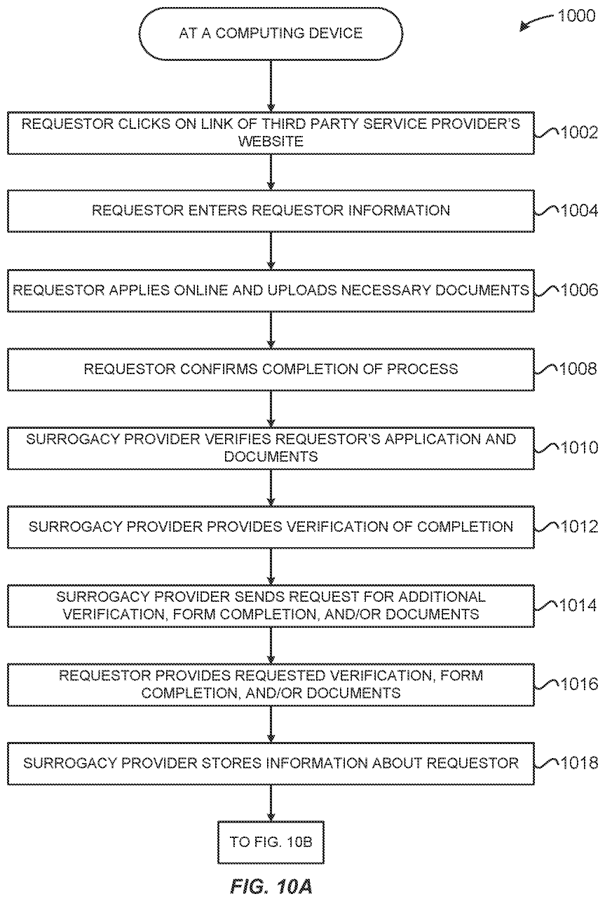

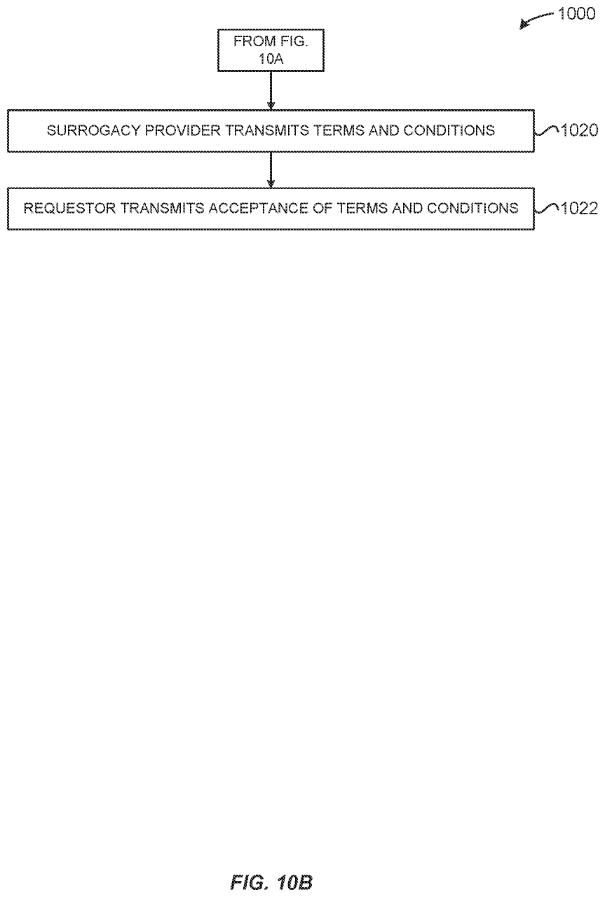

As illustrated in FIGS. 10A-10B, in some embodiments, a method 1000 for surrogacy is disclosed. In some embodiments, instructions are stored on a memory device that, when executed by a processor, cause the processor to perform the steps of method 1000.

At 1002, a requestor may click on a link on a third-party service provider's website (e.g., a shopping website), which will take the applicant to a website associated with a surrogacy provider. The website may include a welcome message, purpose statement, theme, logo, date, time, and/or a link to download an application associated with the surrogacy provider.

At 1004, the requestor may enter requestor information, including, but not limited to, one or more of a language, country, detailed location information, and the like. This may be entered within the application associated with the surrogacy provider or via the website associated with the surrogacy provider.

At 1006, the requestor may apply online and upload any documents required by the surrogacy provider. This process may include a save function that allows the requestor to fill out the application partially and return later.

At 1008, the requestor may confirm completion of the process to apply and send the documents required.

At 1010, the surrogacy provider may verify the requestor's application and documents.

At 1012, the surrogacy provider may provide the requestor with a verification of submission.

At 1014, the surrogacy provider may send and the requestor may receive a request for more verification, form completion, and/or more documents.

At 1016, the requestor may provide the requested verification information, provide the requested documents and/or edit their application based on surrogacy provider's request.

At 1018, the surrogacy provider may store information about the requestor.

At 1020, the surrogacy provider may transmit and the requestor may receive terms and conditions to accept. These terms may include items such as liability release, whether or not insurance is provided, billing terms, subscription cost, etc.

At 1022, the requestor may accept the terms and transmit their acceptance to the surrogacy provider.

The method 1000 may include more or fewer steps than those described above, and the steps of method 1000 may be performed in any suitable order.

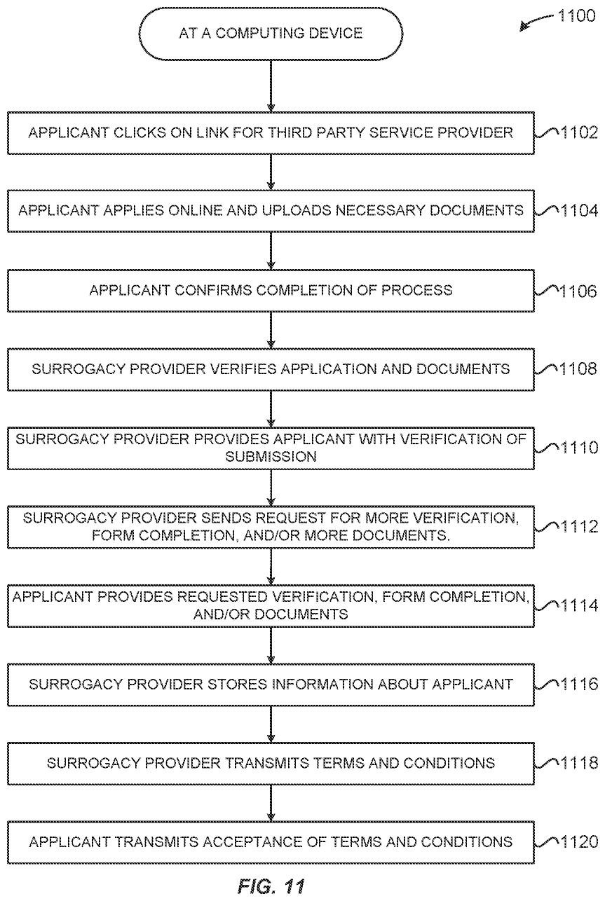

As illustrated in FIG. 11, in some embodiments, a method 1100 for surrogacy is disclosed. In some embodiments, instructions are stored on a memory device that, when executed by a processor, cause the processor to perform the steps of method 1000.

At 1102, an applicant to become a surrogate may click on a link to take the applicant to a website associated with a surrogacy provider. The website may include a welcome message, purpose statement, theme, logo, date, time, and/or a link to download an application associated with the surrogacy provider.

At 1104, the applicant may apply online and upload documents required or requested by the surrogacy provider, providing one or more of the following languages spoken, country, detailed location information, address, whether the applicant can or cannot hold perishables, whether the applicant can or cannot hold large items, whether the applicant can or cannot hold heavy items, availability of a driveway for parking, whether the applicant has pets, what kinds of pets the applicant has, availability for scheduled or unscheduled pickups, experience taking care of pets, certifications, criminal background check, state-issued identification cards, time slots available for surrogacy activities, and the like. This may be entered within the application associated with the surrogacy provider or via the website associated with the surrogacy provider.

At 1106, the applicant may confirm completion of the process to apply and send the documents required.

At 1108, the surrogacy provider may verify the applicant's application and documents.

At 1110, the surrogacy provider may provide the applicant with verification of submission.

At 1112, the surrogacy provider may send and the applicant may receive a request for more verification, form completion, and/or more documents.

At 1114, the applicant may provide the information and/or edit their application based on surrogacy provider's request.

At 1116, the surrogacy provider may store information about the applicant.

At 1118, the surrogacy provider may transmit and the applicant may receive terms and conditions to accept. These terms may include items such as liability release, whether or not insurance is provided, payment terms, dispute resolution, etc.

At 1120, the applicant may accept the terms and transmit their acceptance to the surrogacy provider.

The method 1100 may include more or fewer steps than those described above, and the steps of method 1100 may be performed in any suitable order.

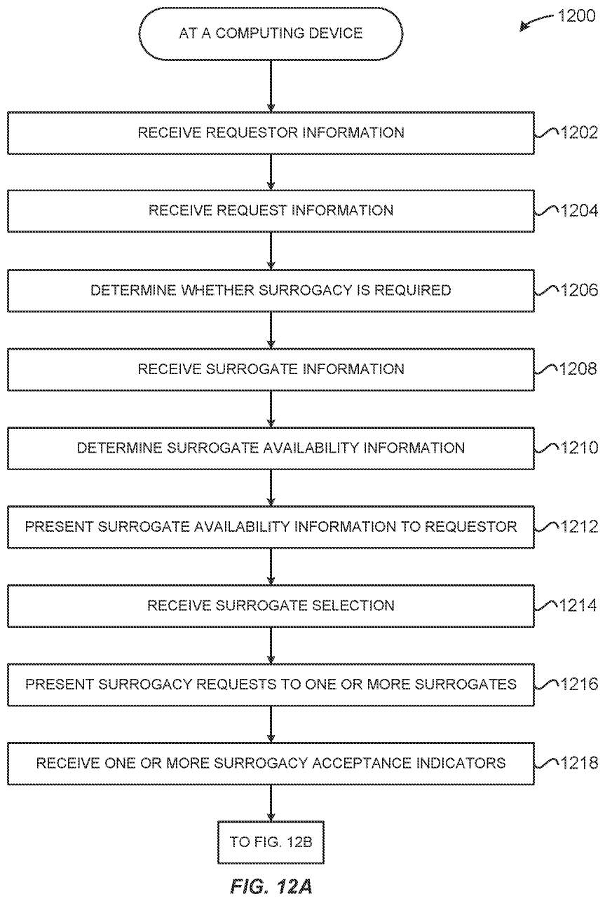

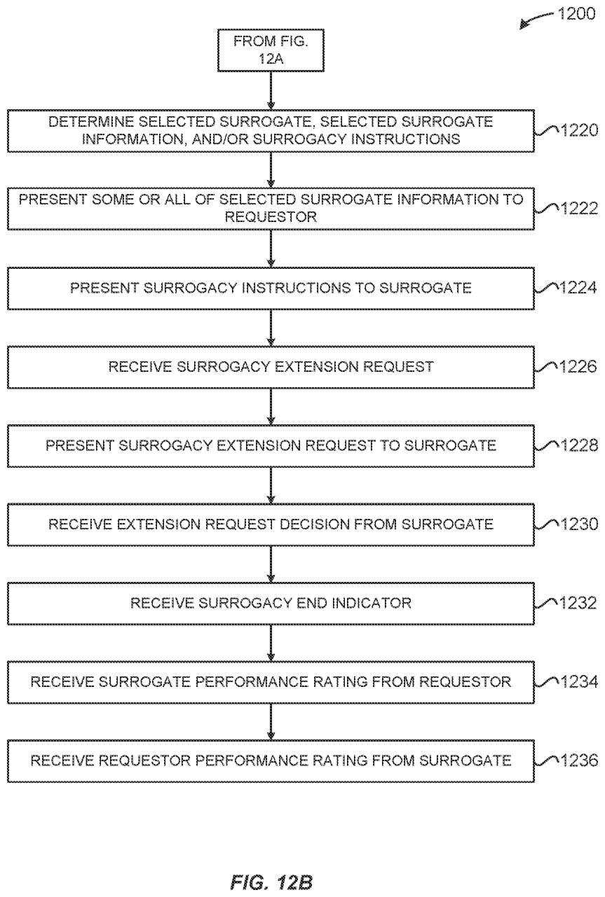

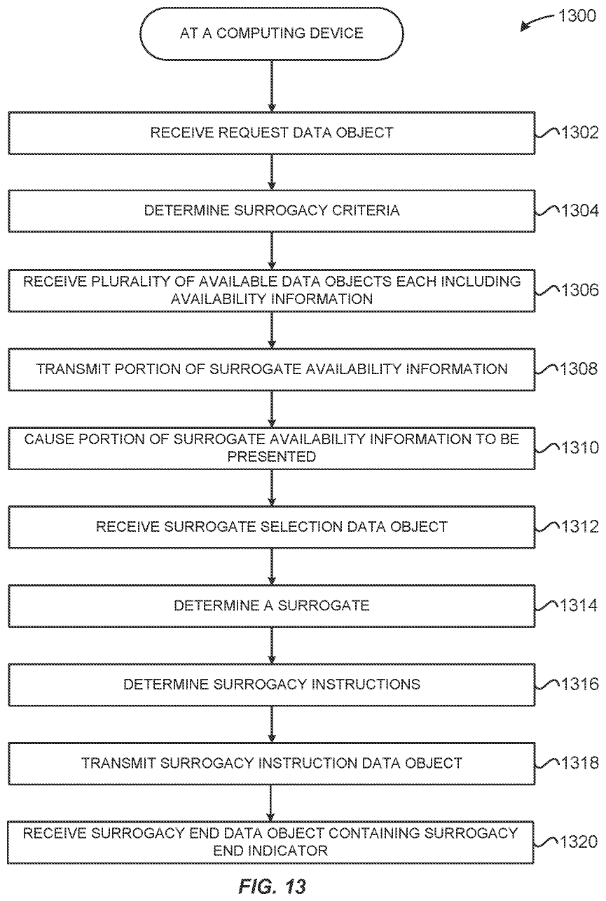

As illustrated in FIGS. 12A-12B, in some embodiments, a method 1200 for surrogacy is disclosed. In some embodiments, instructions are stored on a memory device that, when executed by a processor, cause the processor to perform the steps of method 1200.

At 1202, the method 1200 may include receiving, at a server computing device from a requestor device, a request data object including requestor information. For example, the requestor device 202 may transmit, and the surrogacy provider device 206 may receive, the request data object. Requestor information may include the requestor's anticipated service location or delivery location, information about the requestor's schedule, payment information for the requestor, a verified or unverified ID of the requestor, and the like.

At 1204, the method 1200 may include receiving, at the server computing device from the requestor computer device request information. The request information may be included in the request data object. Request information may be received from a third-party service provider, such as a shipping company (e.g., a postal service) or a store (e.g., a grocery store). Request information may be based on the requestor information. Request information may include information about a service to be performed, such as package reception, childcare, elderly care, disabled person care, pet care, and the like. Request information may include a location, such as a specified location that the requestor may wish to eventually move a package to (i.e., the requestor could have a surrogate receive the package, which the requestor could pick up and move to the specified location; such information may be valuable by allowing the requestor to pick up the package close to the requestor's specified location. Request information may include a planned or expected driving route (i.e., the requestor could have the surrogate receive the package, which the requestor could pick up on their way to another location, like home; it may be less disruptive to the to the requestor or other parties). Request information may include a service time, such as a delivery window. Request information may include a pickup time for a package. Request information may include whether packages (e.g., groceries) need to be refrigerated or frozen. Request information may include requestor schedule information; requestor schedule information may be used to determine whether a service is required. Request information may include care information (e.g., information about a person, such as a child, an elderly person, a disabled person, a pet, or the like that need to be monitored and/or cared for and what services may or will be required as a part of that care). Request information may include an expected time for the service, expected duration of the service, probability that the service be extended, and the like.

At 1206, the method 1200 may include determining, based on the requestor information and the request information, whether surrogacy is required. For example, the processor 106 of the surrogacy provider device 206 may determine, based on the requestor information and the request information, whether surrogacy is required. For example, if comparing requestor information including the requestor's schedule with request information including the expected delivery time, it may be determined that surrogacy is not required. This may be useful in cases where surrogacy is integrated with a third-party service, such as a shipping or shopping service, and the request information comes from third party service.

At 1208, the method 1200 may include receiving, at the server computing device, a plurality of availability data objects, each of which includes surrogate information including availability information for at least one corresponding surrogate. For example, the surrogacy provider device 206 may receive surrogate information from the surrogate device 204. The surrogate information may be received from surrogates, a third party, or storage based on prior services provided by the surrogate. The surrogate information may include the surrogate's name, address, a verified photo ID, drop-off windows, pickup windows, prior performance ratings, payment reception information (e.g., bank account or payment service details), criminal background information, certifications (e.g., childcare, medical care, etc.), refrigerator and freezer availability, schedule (e.g., for delivery and pickup), and the like.

At 1210, the method 1200 may include, at the server computing device and based on the surrogate information and request information, determining availability information. For example, the processor 106 of the surrogacy provider device 206 may, based on the surrogate information and the request information, determine availability information. For example, determining the availability information may include comparing expected service time (e.g., delivery time and pickup time, etc.) to the schedule of the surrogates. Determining the availability information may include comparing the service required with certifications of the surrogates (e.g., if a child needs to be monitored or cared for, determining whether any of the available surrogates have any form of certifications). The availability information may include names, addresses, availability windows, certifications, distance from specified location, distance from the planned or expected driving route, ability to hold perishable items, ability to hold large items, ability to hold heavy items, availability of a driveway for parking, quantity of pets owned if any, availability for scheduled and unscheduled holds, and the like of surrogates.

At 1212, the method 1200 may include, at the server computing device and based on the availability, presenting some or all of the availability information of one or more surrogates to the requestor. For example, the surrogacy provider device 206 may cause some or all of the availability information to be presented on the output device 112 of the requestor device 202. Some information may not be presented for the sake of the one or more surrogates' privacy. For example, cross streets may be displayed, but street addresses may not. In some embodiments, the availability information may be presented on a map to allow for selection of the surrogate by the requestor based on the location of the surrogates. In some embodiments, the availability information appears in a grid and may be organized based on proximity to the requestor's address or travel route.

At 1214, the method 1200 may include, at the server computing device, receiving a surrogate selection from the requestor. For example, the requestor may input a selection via the input device 110 of the requestor device 202, which the requestor device 202 may transmit to the surrogacy provider device 206. The surrogate selection may include one or more surrogates selected by the requestor.

At 1216, the method 1200 may include causing to be presented, to one or more surrogates, one or more surrogacy requests for the one or more surrogates to accept or reject. For example, the surrogacy provider device 206 may transmit one or more surrogacy requests to one or more surrogate devices 204 and cause the surrogacy requests or a representation thereof to be presented on respective output devices 112 of the one or more surrogate devices 204. The surrogacy requests may include information about the requestor and the requestor's needs. Some information associated with the requestor (e.g., age, street address, etc.) may not be transmitted or presented for the sake of the requestor's privacy.

At 1218, the method 1200 may include receiving, at the server computing device from one or more surrogates, one or more surrogacy acceptance indicators indicating that one or more surrogates have respectively accepted surrogacy requests. For example, one or more surrogates may indicate their acceptance via respective input devices 110 of respective surrogate devices 204, and the respective surrogate devices may transmit surrogacy acceptance indicators to the surrogacy provider device 206, which receives the surrogacy acceptance indicators.

At 1220, the method 1200 may include, at the server computing device, determining a selected surrogate, selected surrogate information, and/or surrogacy instructions. For example, the processor 106 of the surrogacy provider device 206 may determine selected surrogate, selected surrogate information, and/or surrogacy instructions. Determining the selected surrogate, selected surrogate information, and/or surrogacy instructions may be based on one or more of the requestor information, request information, the surrogate selection, and the surrogacy acceptance indicators. The surrogacy instructions may include requestor contact information. The surrogacy contact information may be anonymized contact information (e.g., a phone number provided by a surrogacy provider or a third-party service provider that acts as an intermediary between the requestor and the surrogate). The surrogacy instructions may include time of drop-off, time of pick-up, storage requirements (e.g., refrigerator or freezer), number of pets, pet care instructions, number of children, childcare instructions, check-in instructions, number of seniors, senior care instructions, and the like.

At 1222, the method 1200 may include, at the server computing device, presenting, to the requestor, some or all of the selected surrogate information. For example, the surrogacy provider device 206 may cause some or all of the selected surrogate information to be presented on the output device 112 of the requestor device 202. The selected surrogate information may include surrogate contact information. The surrogate contact information may be anonymized contact information (e.g., a phone number provided by a surrogacy provider or a third-party service provider that acts as an intermediary between the requestor and the surrogate).

At 1224, the method 1200 may include, at the server computing device, presenting, to the selected surrogate, surrogacy instructions. For example, the surrogacy provider device 206 may cause surrogacy instructions to be presented on the output device 112 of the surrogate device 204.

At 1226, the method 1200 may include, at the server computing device, receiving a surrogacy extension request. For example, the requestor may input a surrogacy extension request via the input device 110 of the requestor device 202, which the requestor device 202 may transmit for the surrogacy provider device 206 to receive. The surrogacy extension request may be received from the requestor (e.g., the requestor will be late and their child may need to be cared for over a longer period of time than was initially agreed upon).

At 1228, the method 1200 may include causing the surrogacy extension request to be presented to the surrogate. For example, the surrogacy provider device 206 may transmit the surrogacy extension request to the surrogate device 204 and cause the surrogacy extension request to be displayed on the output device 112 of the surrogate device 204.

At 1230, the method 1200 may include receiving, at the server computing device, an extension request decision from the surrogate.

At 1232, the method 1200 may include receiving, at the server computing device, a surrogacy end data object including a surrogacy end indicator. For example, the surrogacy provider device 206 may receive the surrogacy end data object including the surrogacy end indicator indicating that the surrogacy task is complete. The surrogacy end data object may be received from the surrogate (i.e., from the surrogate device 204). The surrogacy end data object may be received from the requestor (i.e., from the requestor device 202).

At 1234, the method 1200 may include receiving, at the server computing device, a surrogate performance data object including a surrogate performance rating. For example, the requestor may input a surrogate performance rating by way of the input device 110 of the requestor device 202, and the requestor device 202 may transmit a surrogate performance data object including the surrogate performance rating for the surrogacy provider device 206 to receive. The surrogate performance rating may be one or more ratings covering areas such as requestor responsiveness, requestor timeliness, requestor politeness, etc.

At 1236, the method 1200 may include receiving, at the server computing device, a requestor performance data object including a requestor performance rating. For example, the surrogate may input a requestor performance rating by way of the input device 110 of the surrogate device 204, and the surrogate device 204 may transmit a surrogate performance data object including the surrogate performance rating for the surrogacy provider device 206 to receive. The requestor performance rating may be one or more ratings covering areas such as availability, surrogate timeliness, surrogate politeness, etc.

The method 1200 may include more or fewer steps than those described above, and the steps of method 1200 may be performed in any suitable order.

In some embodiments, a method 1300 for surrogacy is disclosed. In some embodiments, instructions are stored on a memory device that, when executed by a processor, cause the processor to perform the steps of method 1300.

At 1302, the method 1300 may include receiving a request data object from a requestor device. For example, the surrogacy provider device 206 may receive a request data object from the requestor device 202. In some embodiments, the request data object may include requestor location. In some embodiments, the request data object may include storage requirements. In some embodiments, the storage requirements may include cold storage requirements. In some embodiments, the request data object may include pet monitoring. In some embodiments, the request data object may include child or senior monitoring. In some embodiments, the request data object may include package delivery. In some embodiments, the request data object may include grocery delivery.

At 1304, the method 1300 may include, based on the request data object, determining surrogacy criteria. For example, the processor 106 of the surrogacy provider device 206 may determine, based on the request data object, the surrogacy criteria. In some embodiments, the surrogacy criteria includes physical proximity between the requestor location and the surrogate location. In some embodiments, the surrogacy criteria may include the storage requirements. In some embodiments, the surrogacy criteria includes the cold storage requirements.

At 1306, the method 1300 may include receiving a plurality of availability data objects each including availability information for at least one corresponding surrogate. For example, the surrogacy provider device 206 may receive availability information from the surrogate device 204 or the surrogate database 402. In some embodiments, the availability information may include a surrogate location. In some embodiments, the availability information may include surrogate storage availability. In some embodiments, the surrogate storage availability includes cold storage availability.

At 1308, the method 1300 may include transmitting at least a portion of the availability information to the requestor device. For example, the surrogacy provider device 206 may transmit at least a portion of the availability information to the requestor device 202.

At 1310, the method 1300 may include causing at least a portion of the transmitted portion of the availability information to be presented on the requestor device. For example, the surrogacy provider device 206 may cause at least a portion of the transmitted portion of the availability information to be presented on the requestor device 202

At 1312, the method 1300 may include receiving a surrogate selection data object from the requestor device including surrogate selection information. For example, the surrogacy provider device 206 may receive a surrogate selection data object including the surrogate selection information from the requestor device 202. In some embodiments, the surrogacy criteria includes the surrogate selection information.

At 1314, the method 1300 may include, based on the surrogacy criteria, determining a surrogate. For example, the processor 106 of the surrogacy provider device 206 may determine, based on the surrogacy criteria, a surrogate.

At 1316, the method 1300 may include, based on the surrogacy criteria and determined surrogate, determining surrogacy instructions. For example, the processor 106 of the surrogacy provider device 206 may determine, based on the surrogacy criteria, surrogacy instructions.

At 1318, the method 1300 may include transmitting a surrogacy instruction data object including the surrogacy instructions to a surrogate device associated with the determined surrogate. For example, the surrogacy provider device 206 may transmit the surrogacy instruction data object to the surrogate device 204.

At 1320, the method 1300 may include receiving surrogacy end data object including a surrogacy end indicator indicating. For example, the surrogacy provider device 206 may receive a surrogacy end data object including a surrogacy end indicator indicating that the surrogacy has ended from one or both of the requestor device 202 and the surrogate device 204.

The method 1300 may include more or fewer steps than those described above, and the steps of method 1300 may be performed in any suitable order.

In some embodiments, an apparatus for online surrogacy is disclosed. The apparatus may include a server computing device including a processor and a memory including instructions that, when executed by the processor, cause the processor to receive a request data object including requestor information and request information from a requestor device. The instructions may further cause the processor to identify, using the request data object, surrogacy criteria corresponding to the requestor information. The instructions may further cause the processor to receive a plurality availability data objects, each availability data object including availability information for at least one corresponding surrogate. The instructions may further cause the processor to determine, based on the surrogacy criteria and the availability information for each respective availability data object, a surrogate. The instructions may further cause the processor to generate, based on the requestor information and the determined surrogate, surrogacy instructions. The instructions may further cause the processor to transmit, to a surrogate device associated with the determined surrogate, a surrogacy instruction data object including the surrogacy instructions.

In some embodiments, wherein the instructions further cause the processor to transmit a surrogacy availability data object including at least a portion of the availability information from the server computing device to the requestor device. In some embodiments, the instructions may further cause the processor to cause at least a portion of the transmitted portion of the availability information to be presented on the requestor device. In some embodiments, the instructions may further cause the processor to receive, from the requestor device, a surrogate selection data object including surrogate selection information. In some embodiments, the surrogacy criteria may include the surrogate selection information. In some embodiments, the request data object may include requestor location. In some embodiments, the availability information may include a surrogate location. In some embodiments, the surrogacy criteria may include physical proximity between the requestor location and the surrogate location. In some embodiments, the instructions may further cause the processor to receive a surrogacy end data object including a surrogacy end indicator. In some embodiments, the request data object may include storage requirements. In some embodiments, the availability information may include surrogate storage availability. In some embodiments, the surrogacy criteria may include the storage requirements. In some embodiments, the storage requirements may include cold storage requirements. In some embodiments, the surrogate storage availability may include cold storage availability. In some embodiments, the surrogacy criteria may include the cold storage requirements. In some embodiments, the request data object may include a pet monitoring request. In some embodiments, the request data object may include a child and/or senior monitoring request. In some embodiments, the request data object may include a package delivery request.

In some embodiments, a method for online surrogacy is disclosed. The method may include receiving, at a server computing device from a requestor device, a request data object including requestor information and request information. The method may further include identifying, using the request data object, surrogacy criteria corresponding to the requestor information. The method may further include receiving, at the server computing device, a plurality availability data objects, each availability data object including availability information for at least one corresponding surrogate. The method may further include determining, based on the surrogacy criteria and the availability information for each respective availability data object, a surrogate. The method may further include generating, based on the requestor information and the determined surrogate, surrogacy instructions. The method may further include transmitting, to a surrogate device associated with the determined surrogate, a surrogacy instruction data object including the surrogacy instructions.

In some embodiments, the method may further include transmitting a surrogacy availability data object including at least a portion of the availability information from the server computing device to the requestor device. In some embodiments, the method may further include causing at least a portion of the transmitted portion of the availability information to be presented on the requestor device. In some embodiments, the method may further include receiving, at the server computing device from the requestor device, a surrogate selection data object including surrogate selection information. In some embodiments, the surrogacy criteria may include the surrogate selection information. In some embodiments, the request data object may include requestor location. In some embodiments, the availability information may include a surrogate location. In some embodiments, the surrogacy criteria may include physical proximity between the requestor location and the surrogate location. In some embodiments, the method may further include receiving a surrogacy end data object including a surrogacy end indicator. In some embodiments, the request data object may include storage requirements. In some embodiments, the availability information may include surrogate storage availability. In some embodiments, the surrogacy criteria may include the storage requirements. In some embodiments, the storage requirements may include cold storage requirements. In some embodiments, the surrogate storage availability may include cold storage availability. In some embodiments, the surrogacy criteria may include the cold storage requirements. In some embodiments, the request data object may include a pet monitoring request. In some embodiments, the request data object may include a child and/or senior monitoring request. In some embodiments, the request data object may include a package delivery request.

In some embodiments, an apparatus may include a processor and a memory including instructions that, when executed by the processor, cause the processor to perform the steps of the method. In some embodiments, a non-transitory computer-readable storage medium may include executable instructions that, when executed by a processor, facilitate performance of the steps of the method.

The above discussion is meant to be illustrative of the principles and various embodiments of the present invention. Numerous variations and modifications will become apparent to those skilled in the art once the above disclosure is fully appreciated. For example, the proceeding methods may further include steps such as displaying associated cross-streets with the list of available surrogates, including a map showing the general locations of the surrogates, only providing contact information to the surrogates or requestor once a surrogacy request has been accepted (e.g., confirmed), verifying an identification (ID) of surrogates, displaying all or a portion of a verified ID or verified ID indicator associated with individual surrogates, receiving reviews and/or comments from requestors relating to the performance of individual surrogates, anonymizing or limiting contact information, requiring further verifications and confirmations, etc. Further, the constituent steps and components of the methods and systems described herein may be combined and organized in any suitable manner. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein may be realized in hardware, software, or any combination thereof. The hardware may include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module may include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module may include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module may include memory that stores instructions executable by a controller to implement a feature of the module.

Further, in one aspect, for example, systems described herein may be implemented using a general-purpose computer or general-purpose processor with a computer program that, when executed, carries out any of the respective methods, algorithms, and/or instructions described herein. In addition, or alternatively, for example, a special purpose computer/processor may be utilized which may contain other hardware for carrying out any of the methods, algorithms, or instructions described herein.

Further, all or a portion of implementations of the present disclosure may take the form of a computer program product accessible from, for example, a computer-usable or computer-readable medium. A computer-usable or computer-readable medium may be any device that can, for example, tangibly contain, store, communicate, or transport the program for use by or in connection with any processor. The medium may be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. An apparatus for online surrogacy comprising:
a server computing device comprising:
a processor; and
a memory including instructions that, when executed by the processor, cause the processor to:
receive a request data object including requestor information and request information from a requestor device;
identify, using the request data object, surrogacy criteria corresponding to the requestor information;
receive a plurality availability data objects, each availability data object including availability information for at least one corresponding surrogate;
determine, based on the surrogacy criteria and the availability information for each respective availability data object, a surrogate;
generate, based on the requestor information and the determined surrogate, surrogacy instructions; and
transmit, to a surrogate device associated with the determined surrogate, a surrogacy instruction data object including the surrogacy instructions.

2. The system of claim 1, wherein the instructions further cause the processor to:
transmit a surrogacy availability data object including at least a portion of the availability information from the server computing device to the requestor device.

3. The system of claim 2, wherein the instructions further cause the processor to:
cause at least a portion of the transmitted portion of the availability information to be presented on the requestor device.

4. The system of claim 2, wherein the instructions further cause the processor to:
receive, from the requestor device, a surrogate selection data object including surrogate selection information; and
wherein the surrogacy criteria includes the surrogate selection information.

5. The system of claim 1, wherein the request data object includes requestor location, the availability information includes a surrogate location, and the surrogacy criteria includes physical proximity between the requestor location and the surrogate location.

6. The system of claim 1, wherein the instructions further cause the processor to:
receive a surrogacy end data object including a surrogacy end indicator.

7. The system of claim 1, wherein the request data object includes storage requirements, the availability information includes surrogate storage availability, and the surrogacy criteria includes the storage requirements.

8. The system of claim 7, wherein the storage requirements include cold storage requirements, the surrogate storage availability includes cold storage availability, and the surrogacy criteria includes the cold storage requirements.

9. The system of claim 1, wherein the request data object includes a pet monitoring request.

10. The system of claim 1, wherein the request data object includes a child or senior monitoring request.

11. The system of claim 1, wherein the request data object includes a package reception request.

12. A method comprising:
receiving, at a server computing device from a requestor device, a request data object including requestor information and request information;
identifying, using the request data object, surrogacy criteria corresponding to the requestor information;
receiving, at the server computing device, a plurality availability data objects, each availability data object including availability information for at least one corresponding surrogate;
determining, based on the surrogacy criteria and the availability information for each respective availability data object, a surrogate;
generating, based on the requestor information and the determined surrogate, surrogacy instructions; and
transmitting, to a surrogate device associated with the determined surrogate, a surrogacy instruction data object including the surrogacy instructions.

13. The method of claim 12, further comprising:
transmitting a surrogacy availability data object including at least a portion of the availability information from the server computing device to the requestor device.

14. The method of claim 13, further comprising:
causing at least a portion of the transmitted portion of the availability information to be presented on the requestor device.

15. The method of claim 13, further comprising:
receiving, at the server computing device from the requestor device, a surrogate selection data object including surrogate selection information; and
wherein the surrogacy criteria includes the surrogate selection information.

16. The method of claim 12, wherein the request data object includes requestor location, the availability information includes a surrogate location, and the surrogacy criteria includes physical proximity between the requestor location and the surrogate location.

17. The method of claim 12, further comprising:
receiving a surrogacy end data object including a surrogacy end indicator.

18. The method of claim 12, wherein the request data object includes storage requirements, the availability information includes surrogate storage availability, and the surrogacy criteria includes the storage requirements.

19. The method of claim 18, wherein the storage requirements include cold storage requirements, the surrogate storage availability includes cold storage availability, and the surrogacy criteria includes the cold storage requirements.

20. A non-transitory computer-readable storage medium, comprising executable instructions that, when executed by a processor, facilitate performance of operations, comprising:
receiving, at a server computing device from a requestor device, a request data object including requestor information and request information;
identifying, using the request data object, surrogacy criteria corresponding to the requestor information;
receiving, at the server computing device, a plurality availability data objects, each availability data object including availability information for at least one corresponding surrogate;
determining, based on the surrogacy criteria and the availability information for each respective availability data object, a surrogate;
generating, based on the requestor information and the determined surrogate, surrogacy instructions; and
transmitting, to a surrogate device associated with the determined surrogate, a surrogacy instruction data object including the surrogacy instructions.
